(19) United States
(12) Patent Application Publication
(10) Pub. No.: US 2010/0145731 A1
(43) Pub. Date: Jun. 10, 2010

(54) System and method for computer-generations of diagnoses

(76) Inventor: Anuthep Benja-Athon, New York, NY (US)

Correspondence Address: Anuthep Benja-Athon, 210 E. 36th Street, New York, NY, 10016, US

(21) Appl. No.: 12/658,112

(22) Filed: Feb. 3, 2010

Related U.S. Application Data
(63) Continuation-in-part of application No. 12/592,714, filed on Dec. 2, 2009.
Application No. 12/592,714 is a continuation-in-part of application No. 12/381,654, filed on Mar. 16, 2009.
Application No. 12/381,654 is a continuation-in-part of application No. 12/321,141, filed on Jan. 16, 2009.
Application No. 12/321,141 is a continuation-in-part of application No. 12/069,409, filed on Feb. 11, 2008.
Application No. 12/069,409 is a continuation-in-part of application No. 12/156,674, filed on Jun. 4, 2008.
Application No. 12/156,674 is a continuation-in-part of application No. 11/986,657, filed on Nov. 26, 2007.
Application No. 11/986,657 is a continuation-in-part of application No. 11/803,621, filed on May 16, 2007.
Application No. 11/803,621 is a continuation-in-part of application No. 11/716,062, filed on Mar. 9, 2007.
Application No. 11/716,062 is a continuation-in-part of application No. 11/649,873, filed on Jan. 5, 2007, now abandoned.
Application No. 11/649,873 is a continuation-in-part of application No. 11/637,662, filed on Dec. 13, 2006, now abandoned.
Application No. 11/637,662 is a continuation-in-part of application No. 11/599,847, filed on Nov. 16, 2006.
Application No. 11/599,847 is a continuation-in-part of application No. 11/431,046, filed on May 10, 2006.
Application No. 11/431,046 is a continuation-in-part of application No. 11/543,895, filed on Oct. 6, 2006, now abandoned.
Application No. 11/543,895 is a continuation-in-part of application No. 11/523,945, filed on Sep. 21, 2006, now abandoned.
Application No. 11/523,945 is a continuation-in-part of application No. 11/510,820, filed on Aug. 28, 2006, now abandoned.
Application No. 11/510,820 is a continuation-in-part of application No. 11/477,121, filed on Jun. 29, 2006, now abandoned.
Application No. 11/477,121 is a continuation-in-part of application No. 11/327,973, filed on Jan. 9, 2006, now abandoned.
Application No. 11/327,973 is a continuation-in-part of application No. 11/114,763, filed on Apr. 27, 2005, now abandoned.
Application No. 11/114,763 is a continuation-in-part of application No. 11/196,823, filed on Aug. 4, 2005, now abandoned.
Application No. 11/196,823 is a continuation-in-part of application No. 11/973,866, filed on Oct. 11, 2007.
Application No. 11/973,866 is a continuation-in-part of application No. 11/293,689, filed on Dec. 5, 2005, now abandoned.
Application No. 11/293,689 is a continuation-in-part of application No. 11/150,878, filed on Jun. 13, 2005, now abandoned.
Application No. 11/150,878 is a continuation-in-part of application No. 11/074,236, filed on Mar. 7, 2005, now abandoned.
Application No. 11/074,236 is a continuation-in-part of application No. 11/022,410, filed on Dec. 27, 2004, now abandoned.
Application No. 12/592,714 is a continuation-in-part of application No. 12/322,529, filed on Feb. 4, 2009.
Application No. 12/322,529 is a continuation-in-part of application No. 12/080,433, filed on Apr. 3, 2008.
Application No. 12/080,433 is a continuation-in-part of application No. 12/072,097, filed on Feb. 25, 2008.
Application No. 12/072,097 is a continuation-in-part of application No. 11/242,461, filed on Oct. 4, 2005, now abandoned.

(51) Int. Cl. G06Q 50/00; G06F 17/30

(52) U.S. Cl. 705/3; 705/2; 707/802; 707/E17.044

(57) ABSTRACT

A system and method for deducing diagnoses by a computer server or servers using data on compiled diagnoses and related chief complaints and health and health-care information in databases and inputs on chief complaints and related information by physicians and patients.

This application is a continuation-in-part of ABA0110 filed Jan. 7, 2010 entitled the Artificial-intelligent system and method for managing health-care, a continuation-in-part of U.S. Ser. No. 12/592,714 entitled the Healthcare Exchange IV filed Dec. 2, 2009, a continuation-in-part of U.S. Ser. No. 12/381,654 filed Mar. 16, 2009 entitled the Adaptable compositions of health information, a continuation-in-part of U.S. Ser. No. 12/322,529 entitled the Healthcare Exchange II filed Feb. 4, 2009, a continuation-in-part of U.S. Ser. No. 12/321,141 entitled the Best system of health and health-care data management filed Jan. 16, 2009, a continuation-in-part of U.S. Ser. No. 12/080,433 entitled The Healthcare Exchange filed Apr. 3, 2008, a continuation-in-part of U.S. Ser. No. 12/069,409 entitled the Filing of Health and Health-care data filed Feb. 11, 2008, continuation-in-part of U.S. Ser. No. 11/986,657 entitled A hierarchy of medical word headers filed Nov. 26, 2007, a continuation-in-part of U.S. Ser. No. 11/803,621 entitled Patients' and physicians' data management filed May 16, 2007, a continuation-in-part of U.S. Ser. No. 11/716,062 entitled A sieve of words in health-care data filed Mar. 9, 2007, a continuation-in-part of U.S. Ser. No. 11/649,873 entitled A system of calibrating physicians' practices of medicine filed Jan. 5, 2007, a continuation-in-part of U.S. Ser. No. 11/637,662 entitled A vital hierarchy of data on diseases filed Dec. 13, 2006, a continuation-in-part of U.S. Ser. No. 11/599,847 entitled A hybrid intelligence in medicine filed Nov. 16, 2006, a continuation-in-part of U.S. Ser. No. 11/431,046 entitled A system of health-care information management filed Nov. 2, 2006, a continuation-in-part of U.S. Ser. No. 11/543,895 entitled Vital elements of speech recognition filed Oct. 6, 2006, a continuation-in-part of U.S. Ser. No. 11/523,945 entitled The networking of digital health information filed Sep. 21, 2006, a continuation-in-part of U.S. Ser. No. 11/510,820 entitled Words for managing health and health-care information filed Aug. 28, 2006, a continuation-in-part of U.S. Ser. No. 11/477,121 entitled the Medical Vocabulary Templates in Speech Recognition filed Jun. 29, 2006, a continuation-in-part of Fidelity of physicians' thoughts to digital data conversions filed Jan. 9, 2006, a continuation-in-part of U.S. Ser. No. 11/114,763 entitled A system of influencing health-care utilizations filed Apr. 27, 2005, a continuation-in-part of U.S. Ser. No. 11/196,823 entitled Routing of health information files filed Aug. 4, 2005, a continuation-in-part of U.S. Ser. No. 11/973,866 entitled An intelligent system of speech recognizing physicians' data, a continuation-in-part of U.S. Ser. No. 11/293,689 entitled A system of conserving health-care buyers' resources filed Dec. 5, 2005, a continuation-in-part of U.S. Ser. No. 11/150,878 entitled Physicians' optimal management of health information filed Jun. 13, 2005, a continuation-in-part of U.S. Ser. No. 11/074,236 entitled A system of management of health-care resources filed Mar. 7, 2005 and a continuation-in-part of U.S. Ser. No. 11/022,410 entitled Physicians' way of information productions filed Dec. 27, 2004 which are pending.

### FIELD OF INVENTION

Computer-generated medical diagnoses and related from data generated and inputted by physicians.

### BACKGROUND OF THE INVENTION

Since the invention of computer and the like and prior to the present invention, the processing capability of computer servers or networks of computers and servers to computer-process health and health-care information and data to computer-produce diagnoses and related information needed by people in the health-care and medicine heretofore is very limited to impossible. Consequently, the generations of health-care information and data such as, but not limited to, diagnoses and related information and data on health and health-care infra are very limited to impossible. Furthermore, physicians' thought process, memories and ability to process, recall and manage health and health-care information and data vary among physicians and medical and surgical specialties and, in some respects, are much less than those of rudimentary computer server or servers operating the innovative technology provided by the present invention.

The present invention is an improved innovation of said innovations of said pending patent applications wherein by the information and data on health and health-care are created, compiled or pooled and related in databases which are used by and enable said computer server or servers to accurately get, select and display individual diagnoses, individual groups of diagnoses and related differential diagnoses and to accurately get, select, extrapolate or infer and display related and relevant extensive and detailed information and data on health and health-care related to said diagnoses.

The present invention expedite and improve medical-decision and health-care processes and the managements of health-care of patients to serve said people and, together with said pending patent applications, are the only means and solution for solving the current health and health-care woes affecting all Americans and, consequently, they produce the best health-care system the world ever known and have and the benefits for billions of people and humanity are immense.

### SUMMARY OF THE INVENTION

The capability of computer servers or networks of computers and servers to computer-process health and health-care information and data to produce diagnoses and related information needed by people in the health-care and medicine heretofore is very limited to impossible.

The present invention provides a system and method for getting, selecting and displaying individual diagnoses, individual groups of diagnoses and related differential diagnoses by a computer server or servers using information and data comprising compiled diagnoses, chief complaints and related health and health-care information in and manage by a SQL Server and the inputs of chief complaints, reviews of systems, physical examinations and laboratory results related to individual diagnoses and related information submitted by physicians and patients being in same or different locations to said computer server or servers in a network or networks of computers.

### DESCRIPTION OF THE PREFERRED EMBODIMENTS

The present invention is a system and method for artificial-intelligently generating medical diagnoses, individual groups of diagnoses and related differential diagnoses by a computer server or computer servers including server blades and various hardware and equipment configurations, virtual servers such as those sold by VMware, HP and IBM, and their derivatives being used by many large American corporations can and will be used to implement the present invention in a network or networks of computers, portable and wireless electronic communication devices and computer servers including said servers.

Specifically, the present invention is a system and method for deducing individual diagnoses, individual groups of diagnoses and related differential diagnoses by computer server or servers possessing memories, processors, at least a server operating system, a SQL Server, computer scripting languages, Java script, AJAX, HTML, XHTML, a Web browser, Web server and innovative computer programs and software for commanding and communicating with said SQL Server and coupling with said computer scripting language, Web browser and Web server derived from compiled or pooled databases comprising diagnoses, individual groups of diagnoses affecting organs, parts and anatomical sites of humans and related differential diagnoses and chief complaints in and manage by said SQL Server and inputs of information and data comprising chief complaints, reviews of systems, physical examinations, laboratories, imaging, body fluid tests and tissues examinations, organs and anatomical sites and parts of human, family histories, genetics, immunizations and physicians' practices related to said diagnoses by individual physicians, patients, individual groups of physicians and individual groups of physicians and patients henceforth people to said computer server or servers to expedite and improve medical-decision and health-care processes and the managements of health-care of patients to serve people including individual physicians, patients, individual groups of physicians and individual groups of physicians and patients henceforth people.

To understand the preferred embodiments of the present invention, however, it is necessary to mention herein said earlier patent applications including pending patent applications such as, but not limited to, U.S. Ser. No. 12/381,654 entitled the Adaptable Compositions of Health Information, U.S. Ser. No. 12/592,714 entitled the Healthcare Exchange IV, U.S. Ser. No. 12/321,141 entitled The Best System of Health and Health-care Data Management U.S. Ser. No. 12/069,409 entitled the Filing of Health and Health-care data, U.S. Ser. No. 12/322,529 entitled the Healthcare Exchange II and U.S. Ser. No. 12/080,433 entitled The Healthcare Exchange. Said unique and innovative patent applications taught the use and implementation of the categories, headers or headings such as, but not limited to, Evaluation, Diagnosis, Group of Diagnoses, Differential Diagnoses and related compiled or pooled information and data on Chief Complaint, Review of Systems, Physical Examination, Laboratory, Imaging, Body Fluid Tests and Tissue Examinations, Organs, Anatomical Sites and Parts, Family History, Genetics, Immunization and Physicians' Practice to enable and/or facilitate the organization, manipulation, processing and relating of health, health-care and health-care services generated and submitted by physicians in about 85 medical and surgical specialties. Each said heading encompasses a vast amount of information and data including words and terms on or relating to health, health-care and health-care services which are used by physicians of all and diverse medical and surgical practices or specialties for and in the communications of said information and data among and between said physicians and between physicians and patients. Said information and data including said words and terms are found in numerous medical dictionaries and medical and surgical text books, journals, publications, literature and encyclopedias, etc. of said all medical and surgical specialties. For example, in the Evaluation heading, said words and terms number about 20-40 or more and are such as, but not limited to, consultation, brief consultation, intermediate consultation, comprehensive consultation, office visit, brief office visit, intermediate office visit, examination, reexamination, follow-up, etc.; in the heading of Laboratory comprises imaging, blood and tissue tests, analyses and examinations, electrodiagnosis, said words and terms number approximately many hundreds such as, but not limited to, x-rays, MRI's, CTScan's, PET Scans of various parts of the body, various types of blood tests, urinalyses, pathological analyses which are used by physicians in about 85 medical and surgical specialties or practices. However, in each of other said headings, said words and terms are very extensive. For example, under Diagnosis heading, there are all words and terms used and use by physicians in about 85 medical and surgical specialties on diagnoses of human diseases, illnesses and disorders; in Treatment heading, there are all words and terms used and use by physicians in about 85 medical and surgical specialties on the treatments of human diseases, illnesses and disorders such as, but not limited to, medical acupuncture, excision drainage, trigger point injection, bursa injection, vaccinations, etc.; in the Surgery heading, there are all words and terms used and use by physicians in about 85 medical and surgical specialties on the surgeries and surgical procedures of human diseases, illnesses and disorders such as, but not limited to, burr hole, craniotomy, cholecystectomy, splenectomy, arthroscopy, endoscopy, resections, etc.; in Medication heading, there are all medications and related information present in the Physicians' Desk Reference used and use by physicians in about 85 medical and surgical specialties. Anatomical structures and names are also used.

As taught by said pending patent applications of the applicant of the present invention, innovative systems, methods and compiled or pooled and related databases in and manage by said SQL Server comprising diagnoses, individual groups of diagnoses affecting human organs, parts and anatomical sites and related differential diagnoses and related compiled or pooled information and data on chief complaints, reviews of systems, physical examinations, laboratories, imaging, body fluid tests and tissues examinations, organs and anatomical sites and parts of human, family histories, genetics, immunizations and physicians' practices related to said diagnoses on diseases, disorders and illnesses in about 85 medical and surgical specialties or practices generated by physicians in about 85 medical and surgical specialties or practices henceforth information and data on health and health-care were invented, created and implemented by said applicant enabling said computer server or servers to artificial-intelligently get, select and display individual diagnoses, individual groups of diagnoses affecting human organs, parts and anatomical sites and related differential diagnoses from said compiled or pooled and related databases using inputs of words and terms representing chief complaints related to individual diagnoses by people to said computer server or servers which is or are enable to computer-deducing individual diagnoses.

Said pending patent applications taught a system and method for creating compiled or pooled and related databases in and manage by said SQL Server comprising diagnoses, individual groups of diagnoses affecting human organs, parts and anatomical sites and related differential diagnoses and related compiled or pooled information and data on chief complaints, reviews of systems, physical examinations, laboratories, imaging, body fluid tests and tissues examinations, organs and anatomical sites and parts of human, family histories, genetics, immunizations and physicians' practices by physicians.

Said U.S. Ser. No. 12/381,654 entitled the Adaptable Compositions of Health Information taught a system and method for producing individual compositions of all or almost all DIAGNOSES known to and used by any and all physicians. Further to said U.S. Ser. No. 12/381,654, more research by the applicant of the present invention to provide the present invention with improvements in the compilations of said information and data on health and health-care. As a preferred embodiment of the present invention, said innovative computer programs and software were invented to command and control said SQL Server to create and store a database or databases comprising diagnoses submitted to said computer server or servers by said physicians in 85 medical and surgical specialties or practices as two of the preferred embodiments of databases created in and by one system of database creation for use by the present invention to achieve the goals and objectives of the present invention as follow:

First in said one system of database creation, a physician or a plurality of physicians in about 85 medical and surgical specialties or practices can submit diagnoses into a database or databases in and manage by said SQL Server. Said compositions of almost all, approximately all or all diagnoses in about 85 medical and surgical specialties in said database are not related to the specialties of said physicians and not related to categories and subcategories, subheadings or topics in said medical and surgical specialties such as, but not limited to, Autonomic Disorders, Connective Tissue Diseases, Ischemic Heart Diseases, Bacterial Infections, Viral Infections, Nosocomial Infections, Gastrointestinal Disorders, Movement Disorders, etc. which are well organized and presented in most medical and surgical textbooks and said diagnoses can be retrieved and used by any and all physicians—regardless of specialty or practice identification in said computers and computer servers—as compositions of almost all, approximately all or all diagnoses composed by said physician or physicians in 85 medical and surgical specialties or practices using one method or both methods infra. As one of the preferred embodiments, said database is used by said computer server or servers to achieve the goals and objective of the present invention. Furthermore, said database can and will be retrieved, for example, in the HTML by physicians to continually manage, edit and improve and submit, store, relate, compile in said databases in and manage by said SQL server.

Further to supra, additionally, database or databases comprising chief complaints and/or reviews of systems, physical examinations, laboratories, imaging, body fluid tests and tissues examinations, human organs and anatomical sites and parts, family histories, genetics, immunizations and physicians' practices related to said diagnoses are created or generated by said physicians which empowered the present invention as described infra and said pending patent applications.

Second, concurrence in said one system of database creation, improving the teaching, system and method in said U.S. Ser. No. 12/381,654, concurrent to said physicians in about 85 medical and surgical specialties or practices submitting said diagnoses into a database in and manage by said SQL Server, said diagnoses are submitted to the database or databases wherein said diagnoses are related to the specialties of said physicians and categories and subcategories or subheadings of diseases, disorders and illnesses and said diagnoses can be retrieved as organized or grouped diagnoses under said categories and subcategories or subheadings and specialties and used more precisely relating to groups of said diseases, disorders and illnesses by specialty-specified physicians in 85 medical and surgical specialties or practices using one method or both methods infra. As one of the preferred embodiments, said databases can and will be retrieved, for example, in the HTML as interactive panels of boxes or the like or similar for and by said physicians to continually manage, edit and improve and submit, store, relate, compile in said databases in and manage by said SQL server. Further to supra, additionally, databases comprising chief complaints and/or reviews of systems, physical examinations, laboratories, imaging, body fluid tests and tissues examinations, human organs and anatomical sites and parts, family histories, genetics, immunizations and physicians' practices related to said diagnoses are created or generated by said physicians which empowered the present invention and said pending patent applications.

In other words, a physician or a plurality of physicians can submit individual single submissions of said diagnoses into a first database comprising almost all or all diagnoses not related to the specialties of physicians and not related to categories and subcategories or subheadings of diseases, disorders and illnesses and, simultaneously, into a second database comprising almost all or all diagnoses related to the specialties of physicians and related to categories and subcategories or subheadings of diseases, disorders and illnesses. Moreover, said diagnoses from said first database are also repetitively and independently retrieved by physicians and said diagnoses said second database are also repetitively and independently retrieved by physicians. However, repetitively modified, edited, improved diagnoses—applicable to said first database and second database—submitted as individual single submissions of said modifications, editions or improvements are simultaneously submitted, scanned, compiled or pooled, related and stored in said first database and said second database in and manage by SQL Server. Said processes for creating, generating, managing, editing, improving said databases repetitively recur. Said diagnoses from said first database and second database are used by said computer server or servers and also by physicians in the present invention and said pending patent applications.

Further to supra, in other words, a plurality of physicians can submit individual single submissions of chief complaints related to said diagnoses into a first database comprising chief complaints related to said diagnoses not related to the specialties of physicians and not related to categories and subcategories or subheadings of diseases, disorders and illnesses and, simultaneously, into a second database comprising chief complaints related to said diagnoses related to the specialties of physicians and related to categories and subcategories or subheadings of diseases, disorders and illnesses. Moreover, said chief complaints related to said diagnoses from said first database are also repetitively and independently retrieved by physicians and said chief complaints related to said diagnoses in said second database are also repetitively and independently retrieved by physicians. However, repetitively modified, edited, improved chief complaints related to said diagnoses—applicable to said first database and second database—submitted as individual single submissions of said modifications, editions or improvements are simultaneously submitted, scanned, compiled or pooled, related and stored in said first database and said second database in and manage by SQL Server. Said processes for creating, generating, managing, editing, improving said databases repetitively recur. Said chief complaints related to said diagnoses from said first database and from said second database are used by said computer server or servers and also by physicians in the present invention and said pending patent applications.

Similarly, further to supra, databases comprising individual groups of diagnoses, related differential diagnoses, reviews of systems, physical examinations, laboratories, imaging, body fluid tests and tissues examinations, human organs and anatomical sites and parts, family histories, genetics, immunizations and physicians' practices related to said diagnoses in said settings and embodiments are similarly processed as supra. Said processes for creating, generating, managing, editing, improving said databases repetitively recur. Said information and data from said databases are used by said computer server or servers and also by physicians in the present invention and said pending patent applications.

Further to supra, said pending applications and the present invention provide a process of scanning and checking of said words and terms, in particular scanning and matching said words and terms encompassed by said categories or headers and subcategories or subheadings generated and used and submitted by physicians representing health care and health-care services provided to patients by physicians, see also infra, with said words and terms same as, similar to and/or equivalence of said words and terms in said database or databases in and manage by said SQL Server. In other words, said words and terms including numerics and alphanumerics are continually and perpetually generated and submitted by physicians and are scanned and checked for redundant repeats, doubles or similars and/or errors. Redundant repeats, doubles or similars and/or errors in the submitted information and data are fixed so that there is no redundant duplicate or repeat, double or similar submitted or present in said database or databases, and physicians are shown erroneous words and terms generated and submitted by said physicians so that said physicians are able to change, correct or edit erroneous words and terms. Said information and data are stored, related, compiled in said databases in and manage by said SQL server.

In yet another preferred embodiment of the present invention, said computer server or servers is or are enabled by said computer programs and software to retrieve and display said interactive diagnoses and related chief complaints and related information and data on health and health-care to said people with or without regard to the related specialties of physicians and categories and subcategories or subheadings of diseases, disorders and illnesses to achieve the goals and objectives of said people using the present invention.

In summary, said one system of database creation enabled same physicians in about 85 medical and surgical specialties or practices to create said database or databases on diagnoses and related chief complaints—and related information and data on health and health-care—relating and not relating to specialties of said physicians and categories and subcategories or subheadings of diseases, disorders and illnesses. Said database or databases can and will be repetitively retrieved by said physicians for managing, editing, improving and enlarging in interactive platforms as taught herein and submitted, scanned, related and stored in and manage by said SQL Server from which said databases can be retrieved by physicians as described supra including achieving the objectives and goals of the present invention.

It is to be understood that said descriptions are representations of the preferred embodiments of the present invention and, therefore, it will be appreciated by those skilled in the art and science that various preferred embodiments, adaptations, variations and derivatives may be made and achieved without departing from the spirit and the scope of the claims of the present invention.

In addition, briefly herein although detailed in said pending patent applications, said information and data including words and terms on or relating to health care and health-care services are generated, submitted, stored, related, compiled or pooled in the database or databases in and manage by said SQL server and are retrieved—using computer mice, keyboards, physicians' or patients' fingers on the touch-enabled viewing screens and/or voice-activation and the like—by and displayed to physicians and patients as numerous interactive pop-up and/or drop-down lists and/or menus of words, terms, phrases, sentences, texts, synonyms, acronyms, texts, numbers, graphics, and word and term headers or headings comprising information and data on and relating to said DIAGNOSES on diseases, disorders, health, health-care and health-care services use by physicians of about 85 medical and surgical specialties and practices. Moreover, interactive graphics such as, but not limited to, U.S. Pat. No. 6,132,218 which can be clicked to present pop-up and/or drop-down lists and/or menus of words, terms, phrases, sentences, texts, synonyms, acronyms, texts, numbers, graphics, and word and term headers or headings comprising information and data on and relating to said DIAGNOSES on diseases, disorders, health, health-care and health-care services use by physicians of about 85 medical and surgical specialties and practices viewable and useable by said physicians and/or patients. Furthermore, in the preferred embodiments of said patent applications and the present invention, said word and term headers comprise Diagnosis, Evaluation, Chief Complaint, Review of Systems, Physical Examination, Infectious Diseases, Differential Diagnosis, Laboratories such as, but not limited to, Imaging, Body Fluid Tests and Tissues Examination, Assessment and Plan, Medications, Treatment, Surgery, Recommendations, Guidelines, Referral and Follow-up wherein said information and data including said words and terms are found and/or related.

Said processes leading to the generations and retrievals of numerous interactive pop-ups and/or drop-down lists and/or menus and interactive graphics are used in interactive electronic templates for clicking and/or selecting and generating and submitting said information and data including words and terms already related, compiled and stored in the database or databases in said SQL Server wherein said information and data including said words and terms are retrieved and used—and less keyboarding and therefore less potential errors and more consistent information and data being generated/used and submitted—by physicians to achieve the goals and objectives of the present invention. At least Java Script and AJAX are used to support interactive pop-ups and/or drop-down lists and/or menus and interactive graphics and boxes.

Therefore, physicians of about 85 medical and surgical specialties or practices using computers and/or mobile communication devices from diverse and different locations access said computer server or servers via the Internet can retrieve said interactive electronic templates to generate and/or use and submit said information and data including words and terms including numerics and alphanumerics on or relating to diagnoses of diseases and disorders and related information and data on health and health-care.

However, among said preferred embodiments of said pending patent applications and the present invention is a preferred embodiment wherein physicians still have the option of keyboarding to generate said information and data including said words and terms.

Further to supra, one of the preferred embodiments of said inventions and the present invention is the generation, relating and storage of said information and data including said words and terms and words and terms same as, similar and/or equivalent to said words and terms generated and submitted by said physicians as described supra—in the database or databases of said SQL server and have been generated and implemented by the present patent applicant and the quantity of said words and terms will continue to grow and enlarge as more words and terms are generated, entered and stored in the database or databases in and manage by said SQL Server.

Further to supra, words and terms same as, similar and/or equivalent to said words and terms generated and/or used and submitted by physicians under the headers of health and health-care comprise Diagnosis, Evaluation, Differential Diagnosis, Laboratories, Imaging, Body Fluid Tests and Tissues Examination, Medications, Treatments, Surgeries are stored and related in the database or databases in said SQL Server.

Said unique and innovative pending patent applications and present invention further taught the scanning of submitted information and data including words and terms on health care and health-care services provided to patients by physicians generated and/or used by physicians, as described supra, with words and terms same as, similar to and/or equivalence of said words and terms in the database or databases and checking for redundant repeats, doubles or similars and/or errors. Redundant duplications or repeats, doubles or similars and/or errors in the submitted information and data are fixed so that there is no redundant duplication or repeat, double or similar submitted or present in the database or databases, and physicians are shown erroneous words and terms generated and submitted by said physicians so that said physicians are able to change, correct or edit erroneous words and terms.

Said information and data are repetitively submitted by physicians to said computer server or servers wherein said information and data are repetitively scanned to remove redundant duplications, related, compiled or pooled and stored in said databases in and manage by said SQL Server. Furthermore, associations and updates of said information and data repetitively generated by physicians and repetitively submitted, scanned or checked for redundant duplications or repeats, doubles which are removed or similars and/or errors which are corrected, related, compiled or pooled and stored in said databases in and manage by said SQL Server in said computer server or servers in a network or networks of computers, portable and wireless electronic communication devices and computer servers.

In summary, the present invention and said pending patent applications provide for the unique creations and generations by physicians in 85 medical and surgical specialties or practices of almost or 100%-perfect said information and data on health and health-care in said databases in and manage by said SQL Server which are used by said computer server or servers to get, select and display diagnoses as described infra. Enabled by said computer server or servers and interactive panels of boxes and drop-down lists, etc., said databases in and manage by said SQL Server can be modified, edited, improved and used by any and all physicians—regardless of specialty or practice identification in said computers and computer servers—and by said computer server or servers as compositions of almost all or all diagnoses and related information and data on health and health-care.

It is to be understood that said descriptions are representations of the preferred embodiments of the present invention and, therefore, it will be appreciated by those skilled in the art and science that various preferred embodiments, adaptations, variations and derivatives may be made and achieved without departing from the spirit and the scope of the claims of the present invention.

Therefore, further to supra, said computer server or servers of the present invention possessing memories, processors, at least a server operating system, a SQL Server, computer scripting languages, Java script, AJAX, HTML, XHTML, a Web browser, Web server and innovative computer programs and software for commanding and communicating with said SQL Server and coupling with said computer scripting language, Web browser and Web server is or are empowered by said innovative databases.

The present invention enables said computer server or servers to artificial-intelligently deduce individual diagnoses from the inputs of words and terms including numerics, alphanumerics on chief complaints by said people into said computer server or servers. As taught by said pending ABA0110 filed Jan. 7, 2010 entitled the Artificial-intelligent system and method for managing health-care, said inputs to said computer server or servers can be achieved by people using said preferred embodiments as described supra.

METHOD 1—In other words, for example, by clicking an interactive Chief Complaint present on a view screen of said computer or devices enable by a Web browser, said physician can retrieve and display an interactive query box wherein said physician can enter one alphabet of a word component, an alphanumerical or numerical component, a plurality of alphabets or alphanumerics, a space component or space components, a word component, a space component, a plurality of word components and a plurality of space components, etc. representing chief complaints on and related to individual diagnoses in said query box—as the speed, success of achieving said search and accuracy of said search of said individual diagnoses in and retrieved from said SQL database in and manage by said SQL Server. For a simplistic example, sad physician keyboards into said interactive query box two words—however, the more words, terms, numerics and alphanumerics use by said physician the more precise or accurate the outcome wherein only outcome may comprise 0 or no diagnosis, one diagnosis which is preferred product of one the preferred embodiments of the present invention, a plurality of diagnoses selected, got and displayed by said computer server or server—which are fever vomiting representing two words representing signs and symptoms of chief complaints related to individual diagnoses and expressed by AJAX and related computer programs and software are the following representative pairs—of many pairs or possibilities—of diagnoses and related signs and symptoms—and all individual words and terms use in medicine and/or surgery by physicians are interactive with said physician and interactive headings as described infra as one of the preferred embodiments of the present invention—such as, but not limited to
Acute appendicitis fever vomiting etc.
Acute pancreatitis jaundice vomiting fever etc.
Granulomatous meningitis vomiting fever etc.
more diagnoses
more signs and symptoms etc.
   wherein said etc. represents more signs and symptoms relating to preceding diagnosis.

Although not shown, if the product is one diagnosis which is preferred product of one the preferred embodiments of the present invention, said physician has gotten the diagnosis selected, got from said databases and displayed to said physician by said computer server or servers providing support for the power of computer server or servers empowered by said innovative computer programs and software and databases. In other words, in this circumstance, there is no need for said physician to further use Method 2 infra to achieve the objective or goal of the present invention.

METHOD 2—further to METHOD 1 supra, if null or no diagnosis or a plurality of diagnoses are selected, got and displayed by said computer server or servers to said physician, in addition to said display of one diagnosis supra or no diagnosis or a plurality of diagnoses, individual categories of interactive reviews of systems, physical examinations, laboratories, imaging, body fluid tests and tissues examinations, family histories, genetics, immunizations, organs and anatomical sites and parts related to said one diagnosis or no diagnosis or a plurality of diagnoses—which may be hidden so as not to cause bias in decision-making processes from or shown to said physician on said viewing screen or screens—by computer server or servers. Said processes supra in Method 1 and in said pending applications can be used select or click and submit said information in said interactive category or categories by said physician to said computer server or servers. By using said interactive category or categories, the present invention enabled said computer server or servers to select, get and display one expected diagnosis from said null or no diagnosis or a plurality of diagnoses.

In Method 2 supra, each interactive category can be sequentially submitted by said physician or more than one category can be submitted as a batch of categories by said physician. In other words, having achieved Method 1, said physician may decide to click items in interactive reviews of systems and submit said clicked items or, for example, said physician may click interactive items in said interactive reviews of systems, physical examinations, laboratories, imaging, body fluid tests and tissues examinations to submit said information and data to said computer server or servers.

The present invention further provides a process for repetitively adapting, adjusting and modifying said interactive words and terms representing chief complaints in said process for deducing said individual diagnoses by said people. In other words, if individual outcomes such as, but not limited to, null or no diagnosis or a plurality of diagnoses produced in said Method 1 and/or Method 2 do not meet the need of individuals, said Method 1 and/or Method 2 can be repetitively used by said individuals repetitively adapting, adjusting and modifying said words and terms representing chief complaints and inputted to said computer server or servers.

Further to supra, the present invention also further provides a process for repetitively adapting, adjusting and modifying said words and terms representing chief complaints for retrieving and displaying interactive words and terms representing reviews of systems, physical examinations, family histories, genetics, immunizations, laboratories, imaging, body fluid tests and tissues examinations, human organs and anatomical sites related to said diagnoses and chief complaints by said individuals.

Further to supra, the present invention also further provides a process for repetitively adapting, adjusting and modifying said interactive words and terms representing reviews of systems, physical examinations, family histories, genetics, immunizations, laboratories, imaging, body fluid tests and tissues examinations, human organs and anatomical sites related to said diagnoses and chief complaints by said individuals.

As taught in said pending patent applications, said interactive pop-ups, drop-down lists or menus, interactive graphics and individual interactive panels of interactive □ boxes, etc. represent some of the preferred embodiments of the interactive means for physicians to interactive with said computer server or servers.

Although not limited to the applications of said two methods and said system, said both methods and system enabled said computer server or servers to select, get and display said diagnosis or diagnoses in said example involving one physician, for example, by said innovative computer programs and software of the present invention and said computer programs and software, such as, but not limited to Java Script and scripting language to scan, check and match common, same, equivalent, like or similar words and terms in and among corresponding reviews of systems, physical examinations, laboratories, imaging, body fluid tests and tissues examinations, family histories, genetics, immunizations, organs and anatomical sites and parts of humans input by said people related to said diagnoses and chief complaints by said computer server or servers. Furthermore, simultaneously, distinct, uncommon, matchless, different, unique or unrepeatable words and terms in and among corresponding said reviews of systems, physical examinations, laboratories, imaging, body fluid tests and tissues examinations, family histories, genetics, immunizations, organs and anatomical sites and parts of humans input by said people related to said diagnoses and chief complaints are scanned, checked and matched by said computer server or servers. With said both methods, said computer server or servers performed non-selections of said diagnoses related to common, same, equivalent, like or similar words and terms in and among corresponding reviews of systems, physical examinations, laboratories, imaging, body fluid tests and tissues examinations, family histories, genetics, immunizations, organs and anatomical sites and parts of humans input by said people related to said diagnoses and chief complaints, by said computer server or servers and achieved selections of said one diagnosis at best and null or no diagnosis or a plurality of diagnoses related to uncommon, distinct, matchless, different, unique or unrepeatable words and terms in and among corresponding reviews of systems, physical examinations, laboratories, imaging, body fluid tests and tissues examinations, family histories, genetics, immunizations, organs and anatomical sites and parts of humans input by said people related to said diagnoses and chief complaints by said computer server or servers.

As taught by said pending ABA0110 filed Jan. 7, 2010 entitled the Artificial-intelligent system and method for managing health-care, said computer server or servers can select and get individual groups of diagnoses related to said selected diagnosis or a plurality of diagnoses. Similarly, said computer server or servers can select and get differential diagnoses related to said selected diagnosis or a plurality of diagnoses.

Statistical analyses and reports—using common statistical methods and programs commonly being used in medicine, health-care and sciences—and on the accuracies on said outcomes of said processes and selections relating to said inputs of information and data by said people and generated by said computer server or servers.

It is to be understood that said descriptions including said methods are representations of the preferred embodiments of the present invention and, therefore, it will be appreciated by those skilled in the art and science that various preferred embodiments, adaptations, variations and derivatives may be made and achieved without departing from the spirit and the scope of the claims of the present invention.

Said preferred embodiments of the present invention are applicable to and used by individual physicians, individual patients, individual groups of physicians and individual groups of physicians and individual patients in same and diverse and different settings and locations. In other words, the preferred embodiments of the present invention are also enabled by popular commercial technologies provided www.webex.com by Cisco Systems, Inc. and www2.gotomeeting.com by Citrix Online, L.L.C. and the like provided by other companies or corporations for enabling individual persons in various and different settings and locations to conference or use said embodiments as individual groups of people being in said diverse or different settings and locations using said network or networks and the Internet to achieve the goals and objectives of the present invention.

Said outcomes and generations of said processes and related chief complaints, reviews of systems, physical examinations, laboratories, imaging, body fluid tests and tissues examinations, organs and anatomical sites and parts of human, family histories, genetics, immunizations and physicians' practices are displayed on the view screens of said computers, portable and wireless electronic communication devices in said network or networks.

It is to be understood that said preferred embodiments and examples apply to physicians and information and data on diseases and disorders in about 85 medical and surgical specialties or practices.

It is to be understood that the present invention comprising method, processes, system, protocols, matters, products, functions and related and derivatives—implemented, effect and operate by said innovative computer software and program operating in said computer server or servers—are far more complex, extensive, intelligent, versatile and more than two dimensional and more versatilely, logically and relationally organized, arranged and presented than said brief and simple representations herein.

Although it has been described in pending earlier patent applications, said data and information are words, terms, word and term headers and topics and subjects as shown above such as, but not limited to, Evaluation, Chief Complaints, Review of Systems, Diagnoses, Differential Diagnoses, Physical Examinations, Medications, Treatments, Surgeries, etc., phrases, synonyms, codes, numbers, sentences, texts and graphic, etc. used and use by physicians in all—approximately 85—medical and surgical specialties and practices to describe and document data and information on diseases, illnesses, disorders, health and health-care of patients and health-care services. At least Java Script and AJAX are used to support said templates, lists and menus.

The method, processes, system, protocols, matters, products, functions and related and derivatives of the present invention are implemented and effected by an innovative computer software and program invented and developed by the present patent applicant which were filed with and are stored in the Library of Congress in Washington, D.C. The present invention uses also the commercially available computer software (plural), programs and computer languages such as, but not limited to, those made and sold by Microsoft Corporation such as, but not limited to, Microsoft Windows Server, SQL such as, but not limited to Microsoft SQL Server, MySQL and the like, Internet Explorer, Web browsers, Web server, Apache, Microsoft IIS, Visual Studio and .Net, Microsoft software including Notepad, Wordpad and .txt programs and their derivatives and the like and related and their database, databases and derivatives, other computer corporations' and companies' programs, languages, codes and databases and their derivatives which are commonly and routinely used by computer engineers and programmers such as, but not limited to, PHP, PERL, C languages, such as, but not limited to, C, C+, C++, C#, JAVA, Java Script, AJAX, HTML, XHTML and the like and related and their derivatives. Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives.

The standard commercial hardware and equipment being used in the TCP/IP networks and the like or equivalence such as, but not limited to, the Internet commerce are implemented and deployed per standard industrial practices and use hardware and equipment such as, but not limited to, computer servers and computers such as numerous HP and IBM servers, HP and Dell computers, Cisco routers and related, and various equipment including modems sold, lease, own and operate by cable companies such as, but not limited to, Time Warner and Optimum Online in New York, etc. Currently, HP ProLiant ML350 and ML110 Generation 4p Servers—see www.hp.com for details of the server hardware and internal design—and similar Dell server—see www.dell.com for details of the server hardware and internal design—used by the present patent applicant as the hardware wherein the computer programs and software(s) mentioned herein operate. It is obvious and known that with more extensive operations, requirements and equipment, server blades and various hardware and equipment configurations, virtual servers such as those sold by VMware, HP and IBM, and their derivatives being used by many large American corporations can and will be used to implement the present invention.

Although a sequence of applications of individual words and terms representing diagnoses, individual groups of diagnoses and related compiled or pooled chief complaints, differential diagnoses, reviews of systems, physical examinations, family histories, genetics, immunizations, laboratories, imaging, body fluid tests and tissues examinations, assessments and plans, medications, treatments, procedures, surgeries, recommendations, guidelines, referrals, follow-ups, organs and anatomical sites and parts of humans and physicians' practices related to said diagnoses or said individual groups of diagnoses as one of the preferred embodiments of the present invention have been described, it is to be appreciated and understood by those skilled in the art that various combinations, permutations and orders of sequences of applications of said words, terms and phrases are some of the preferred embodiments of the present invention and are made, used and achieved without departing from the spirit and the scope of the claims of the present invention.

It is to be understood that a computer server or computer servers capable of deducing diagnoses of the present invention also embody any and all computers and mobile computers such as, but not limited to, and server blades and various hardware and equipment configurations, virtual servers such as those sold by VMware, HP and IBM, and their derivatives being used by many large American corporations can and will be used to implement the present invention.

Although the preferred embodiments of this invention have been described for humans, it will be appreciated by those skilled in the art that adaptations and variations of the present invention may be made to apply to other species, animals, biological entities or structures, infectious particles or structures, and machines without departing from the spirit of the invention and the scope of the claims.

Although various preferred embodiments of the present invention have been described, it will be appreciated by those skilled in the art that their adaptations, variations and derivatives may be made and achieved without departing from the spirit and the scope of the claims of the present invention.

1. A system for deducing individual diagnoses, individual groups of diagnoses and related differential diagnoses by computer server or servers possessing memories, processors, at least a server operating system, a SQL Server, computer scripting languages, Java script, AJAX, HTML, XHTML, a Web browser, Web server and innovative computer programs and software for commanding and communicating with said SQL Server and coupling with said computer scripting language, Web browser and Web server derived from compiled or pooled databases comprising diagnoses, individual groups of diagnoses affecting organs, parts and anatomical sites of humans and related differential diagnoses and chief complaints in and manage by said SQL Server and inputs of information and data comprising chief complaints, reviews of systems, physical examinations, laboratories, imaging, body fluid tests and tissues examinations, organs and anatomical sites and parts of human, family histories, genetics, immunizations and physicians' practices related to said diagnoses by individual physicians, patients, individual groups of physicians and individual groups of physicians and patients henceforth people to said computer server or servers to expedite and improve medical-decision and health-care processes and the managements of health-care of patients to serve people including individual physicians, patients, individual groups of physicians and individual groups of physicians and patients henceforth people comprises:
a compiled or pooled database comprising diagnoses in and manage by said SQL Server;
a compiled or pooled database comprising diagnoses and related chief complaints in and manage by said SQL Server;
compiled or pooled databases comprising diagnoses, individual groups of diagnoses and differential diagnoses and related compiled or pooled information and data on reviews of systems, physical examinations, laboratories, imaging, body fluid tests and tissues examinations, organs and anatomical sites and parts of human, family histories, genetics, immunizations and physicians' practices related to said diagnoses generated by physicians henceforth information and data on health and health-care and submitted, scanned to remove redundant duplications, related, compiled or pooled and stored in said databases in and manage by a SQL Server;
associations and updates of said information and data repetitively generated by physicians and repetitively submitted, scanned, related, compiled or pooled and stored in said databases in and manage by said SQL Server in said computer server or servers in a network or networks of computers, portable and wireless electronic communication devices and computer servers;
inputs of information and data on chief complaints, reviews of systems, physical examinations, laboratories, imaging, body fluid tests and tissues examinations, family histories, genetics, immunizations, organs and anatomical sites and parts by people for computer-deducing individual diagnoses, individual groups of diagnoses and related differential diagnoses by computer server or servers;
matches of common, same, equivalent, like or similar words and terms in and among corresponding reviews of systems, physical examinations, laboratories, imaging, body fluid tests and tissues examinations, family histories, genetics, immunizations, organs and anatomical sites and parts of humans input by said people related to said diagnoses and chief complaints by said computer server or servers;
distinct, uncommon, matchless, different, unique or unrepeatable words and terms in and among corresponding reviews of systems, physical examinations, laboratories, imaging, body fluid tests and tissues examinations, family histories, genetics, immunizations, organs and anatomical sites and parts of humans input by said people related to said diagnoses and chief complaints by said computer server or servers;
non-selections of said diagnoses related to common, same, equivalent, like or similar words and terms in and among corresponding reviews of systems, physical examinations, laboratories, imaging, body fluid tests and tissues examinations, family histories, genetics, immunizations, organs and anatomical sites and parts of humans input by said people related to said diagnoses and chief complaints, by said computer server or servers;
selections of said diagnoses related to uncommon, distinct, matchless, different, unique or unrepeatable words and terms in and among corresponding reviews of systems, physical examinations, laboratories, imaging, body fluid tests and tissues examinations, family histories, genetics, immunizations, organs and anatomical sites and parts of humans input by said people related to said diagnoses and chief complaints by said computer server or servers;
selections of individual groups of diagnoses related to said selected individual diagnoses by said computer server or servers;
selections of differential diagnoses related to said selected individual diagnoses by said computer server or servers;
displays of said selections on the view screens of said computers, portable and wireless electronic communication devices;
displays of chief complaints, reviews of systems, physical examinations, laboratories, imaging, body fluid tests and tissues examinations, organs and anatomical sites and parts of human, family histories, genetics, immunizations and physicians' practices related to said selected individual diagnoses, individual groups of diagnoses and differential diagnoses related to said selected diagnoses to said people;
statistical analyses and reports on the accuracies on said selections relating to said inputs of information and data on chief complaints, reviews of systems, physical examinations, laboratories, imaging, body fluid tests and tissues examinations, family histories, genetics, immunizations, organs and anatomical sites and parts of humans by said people; and
displays of said statistical analyses and reports on the view screens of said computers, portable and wireless electronic communication devices.

2. The system according to claim 1 wherein said compiled or pooled database comprising diagnoses in said SQL Server comprises a composition of diagnoses not related to physician specialties and not related to categories and subcategories or subheadings of diseases, disorders and illnesses.

3. The system according to claim 1 wherein said compiled or pooled database comprising diagnoses in said SQL Server comprises a composition diagnoses related to physician specialties and categories and subcategories or subheadings of diseases, disorders and illnesses.

4. The system according to claim 1 wherein said compiled or pooled database comprising diagnoses and related chief complaints in and manage by said SQL Server comprises a composition of chief complaints related to said diagnoses not related to physician specialties and not related to categories and subcategories or subheadings of diseases, disorders and illnesses.

5. The system according to claim 1 wherein said compiled or pooled database comprising diagnoses and related chief complaints in and manage by said SQL Server comprises a composition of chief complaints related to said diagnoses related to physician specialties and related to categories and subcategories or subheadings of diseases, disorders and illnesses.

6. The system according to claim 1 wherein said compiled or pooled databases comprising diagnoses, individual groups of diagnoses and differential diagnoses and related compiled or pooled information and data on reviews of systems, physical examinations, laboratories, imaging, body fluid tests and tissues examinations, organs and anatomical sites and parts of human, family histories, genetics, immunizations and physicians' practices related to said diagnoses generated by physicians comprises compositions of said information and data on health and health-care related to said diagnoses not related to physician specialties and not related to categories and subcategories or subheadings of diseases, disorders and illnesses.

7. The system according to claim 1 wherein said compiled or pooled databases comprising diagnoses, individual groups of diagnoses and differential diagnoses and related compiled or pooled information and data on reviews of systems, physical examinations, laboratories, imaging, body fluid tests and tissues examinations, organs and anatomical sites and parts of human, family histories, genetics, immunizations and physicians' practices related to said diagnoses generated by physicians comprise compositions of said information and data on health and health-care related to said diagnoses related to physician specialties and related to categories and subcategories or subheadings of diseases, disorders and illnesses.

8. In a system for deducing individual diagnoses, individual groups of diagnoses and related differential diagnoses by computer server or servers possessing memories, processors, at least a server operating system, a SQL Server, computer scripting languages, Java script, AJAX, HTML, XHTML, a Web browser, Web server and innovative computer programs and software for commanding and communicating with said SQL Server and coupling with said computer scripting language, Web browser and Web server and compiled or pooled databases comprising diagnoses, individual groups of diagnoses affecting human organs, parts and anatomical sites and related differential diagnoses and chief complaints, reviews of systems, physical examinations, laboratories, imaging, body fluid tests and tissues examinations, organs and anatomical sites and parts of human, family histories, genetics, immunizations and physicians' practices related to said diagnoses henceforth individual categories of information and data in and manage by said SQL Server and inputs of chief complaints and/or other said individual categories of information and data by individual physicians, individual patients, individual groups of physicians and individual groups of physicians and individual patients henceforth people, a method for selecting, getting and displaying individual diagnoses, individual groups of diagnoses and related differential diagnoses from said databases by said computer server or servers using said inputs and said compiled or pooled databases to get and effect the selections of said individual diagnoses, individual groups of diagnoses and differential diagnoses related to said selected individual diagnoses which are displayed to said people using computers and mobile and wireless electronic communication devices in a network or networks of said computers, mobile, portable and wireless electronic communication devices and computer servers to expedite and improve medical-decision and health-care processes and the managements of health-care of patients to serve said people comprises:
a process for creating a database comprising diagnoses in said SQL Server;
a process for creating a database or databases comprising diagnoses and related chief complaints in and manage said SQL Server;
a process for creating said databases in and manage by said SQL Server comprising diagnoses, individual groups of diagnoses, differential diagnoses, reviews of systems, laboratories, imaging, body fluid tests and tissues examinations, physical examinations, family histories, genetics, immunizations, assessments and plans, medications, treatments, procedures, surgeries, recommendations, guidelines, referrals, follow-ups, organs and anatomical sites and parts of humans and physicians' practices related to said diagnoses and chief complaints;
a process for submitting said individual diagnoses, individual groups of diagnoses and related differential diagnoses, chief complaints, reviews of systems, physical examinations, laboratories, imaging, body fluid tests and tissues examinations, organs and anatomical sites and parts of human, family histories, genetics, immunizations and physicians' practices to said computer server or servers creating and storing said compiled or pooled databases in and manage by said SQL Server;
a process for creating said compiled or pooled databases in and manage by said SQL Server;
a process for associating and updating said compiled or pooled databases by physicians repetitively generating and submitting said individual categories of information and data to said computer server or servers scanning, removing redundant duplications or repeats, relating, compiling or pooling and storing said individual categories of information and data in said databases in and manage by said SQL Server;
a process for scanning and removing redundant duplications or repeats, relating, compiling or pooling and storing said individual categories of information and data in said databases in and manage by said SQL Server by said computer server or servers;
a process for inputting and submitting said chief complaints by said people to said computer server or servers;
a process for inputting said chief complaints and/or other said individual categories by said people to said computer server or servers;
a process for getting and effecting the selections of said individual diagnoses, individual groups of diagnoses and differential diagnoses related to said selected individual diagnoses by said computer server or servers;
a process for displaying said selected individual diagnoses to said people;
a process for displaying said selected individual groups of diagnoses related to said selected individual diagnoses to said people;
a process for displaying differential diagnoses related to said selected individual diagnoses to said people;
a process for displaying chief complaints related to said selected individual diagnoses to said people;
a process for displaying reviews of systems, physical examinations, laboratories, imaging, body fluid tests and tissues examinations, organs and anatomical sites and parts of human, family histories, genetics, immunizations and physicians' practices related to said selected individual diagnoses to said people;
a process for displaying chief complaints related to said selected diagnoses to said people;
a process for displaying reviews of systems, physical examinations, laboratories, imaging, body fluid tests and tissues examinations, organs and anatomical sites and parts of human, family histories, genetics, immunizations and physicians' practices related to said selected individual groups of diagnoses related to said selected diagnoses to said people;
a process for displaying chief complaints related to said selected differential diagnoses related to said selected diagnoses to said people; and
a process for displaying reviews of systems, physical examinations, laboratories, imaging, body fluid tests and tissues examinations, organs and anatomical sites and parts of human, family histories, genetics, immunizations and physicians' practices related to said selected differential diagnoses related to said selected diagnoses to said people.

9. The method according to claim 8 where said process for creating a database comprising diagnoses in said SQL Server comprises a process for creating a compiled or pooled database comprising diagnoses of almost all, approximately all or all diagnoses in about 85 medical and surgical specialties not related to physician specialties and not related to categories and subcategories or subheadings of diseases, disorders and illnesses.

10. The method according to claim 8 where said process for creating a database comprising diagnoses in said SQL Server comprises a process for creating a compiled or pooled database comprising diagnoses of almost all, approximately all or all diagnoses in about 85 medical and surgical specialties related to physician specialties and related to categories and subcategories or subheadings of diseases, disorders and illnesses.

11. The method according to claim 8 where said process for creating said databases comprising diagnoses, individual groups of diagnoses and chief complaints, differential diagnoses, reviews of systems, laboratories, imaging, body fluid tests and tissues examinations, physical examinations, family histories, genetics, immunizations, assessments and plans, medications, treatments, procedures, surgeries, recommendations, guidelines, referrals, follow-ups, organs and anatomical sites and parts of humans and physicians' practices related to said diagnoses in and manage by said SQL Server comprises compositions of said information and data on health and health-care related to said diagnoses in said databases wherein said information and data on health and health-care are not related to physician specialties and not related to categories and subcategories or subheadings of diseases, disorders and illnesses.

12. The method according to claim 8 where said process for creating said databases comprising diagnoses, individual groups of diagnoses and chief complaints, differential diagnoses, reviews of systems, laboratories, imaging, body fluid tests and tissues examinations, physical examinations, family histories, genetics, immunizations, assessments and plans, medications, treatments, procedures, surgeries, recommendations, guidelines, referrals, follow-ups, organs and anatomical sites and parts of humans and physicians' practices related to said diagnoses in and manage by said SQL Server comprises compositions of said information and data on health and health-care related to said diagnoses in said databases wherein said information and data on health and health-care are not related to physician specialties and not related to categories and subcategories or subheadings of diseases, disorders and illnesses.

13. The method according to claim 8 where said process for displaying diagnoses, individual groups of diagnoses, differential diagnoses, chief complaints, reviews of systems, physical examinations, laboratories, imaging, body fluid tests and tissues examinations, organs and anatomical sites and parts of human, family histories, genetics, immunizations and physicians' practices related to said selected differential diagnoses related to said selected diagnoses comprises a process for displaying interactive diagnoses, individual groups of diagnoses, differential diagnoses, chief complaints, reviews of systems, physical examinations, laboratories, imaging, body fluid tests and tissues examinations, organs and anatomical sites and parts of human, family histories, genetics, immunizations and physicians' practices to said people.

14. A method for deducing individual diagnoses, individual groups of diagnoses affecting human organs, parts and anatomical sites and related differential diagnoses by computer server or servers deriving said diagnoses from the compiled or pooled databases in and manage by a SQL Server comprising said diagnoses and individual groups of diagnoses and related compiled or pooled information and data on chief complaints, differential diagnoses, reviews of systems, physical examinations, family histories, genetics, immunizations, laboratories, imaging, body fluid tests and tissues examinations, human organs and anatomical sites and parts and physicians' practices related to said diagnoses generated by physicians henceforth information and data on health and health-care which are submitted, scanned to remove redundant duplications or repeats, related, compiled or pooled and stored in said databases in and manage by said SQL Server wherein associations and updates of said information and data repetitively generated by physicians are repetitively submitted, scanned, related, compiled or pooled and stored in said databases in and manage by said SQL Server in a computer server or computer servers in a network or networks of computers, portable and wireless electronic communication devices and computer servers possessing memories, processors, a server operating system, a Web server, and operating at least one computer scripting language, Java script, AJAX, HTML, XHTML, at least one Web browser and innovative computer programs and software for commanding and communicating with said SQL server and coupling with said computer scripting language, computer programs and Web browser for generating and displaying said individual diagnoses, individual groups of diagnoses and related individual differential diagnoses as outcomes of the inputs or applications of said information and data on health and health-care by people to said computer server or servers scanning, checking and matching common, same, equivalent, like or similar and matchless, different, distinct, unique or unrepeatable words and terms in and among corresponding categories related to said diagnoses in said inputted information and data and getting, selecting and displaying said individual diagnoses, individual groups of diagnoses and related individual differential diagnoses and statistical analyses and reports on the accuracies of said selections on the viewing screens of said computers, portable and wireless electronic communication devices viewable and useable by and to serve said people by expediting and improving medical-decision processes and the managements of health-care of people comprises:
a process for creating said databases in and manage by said SQL Server comprising diagnoses, individual groups of diagnoses and chief complaints, differential diagnoses, reviews of systems, laboratories, imaging, body fluid tests and tissues examinations, physical examinations, family histories, genetics, immunizations, assessments and plans, medications, treatments, procedures, surgeries, recommendations, guidelines, referrals, follow-ups, organs and anatomical sites and parts of humans and physicians' practices related to said diagnoses;
a process for creating databases comprising diagnoses and reviews of systems, differential diagnoses, family histories, laboratories, imaging, body fluid tests and tissues examinations and genetics and immunizations, assessments and plans, medications, treatments, procedures, surgeries, recommendations, guidelines, referrals, follow-ups, human organs and anatomical sites and parts related to said diagnoses in and manage by said SQL Server;
a process for creating databases comprising diagnoses and differential diagnoses, reviews of systems, laboratories, imaging, body fluid tests and tissues examinations, physical examinations, family histories, genetics, immunizations, assessments and plans, medications, treatments, procedures, surgeries, recommendations, guidelines, referrals, follow-ups, organs and anatomical sites and parts of humans and physicians' practices related to said diagnoses in and manage by said SQL Server;
a process for creating a database or databases comprising diagnoses in said SQL Server;
a process for creating a database or databases comprising diagnoses and related chief complaints in and manage said SQL Server;
a process for creating a database or databases comprising diagnoses and related differential diagnoses in and manage said SQL Server;
a process for creating databases comprising diagnoses and related reviews of systems, laboratories, imaging, body fluid tests and tissues examinations, physical examinations, family histories, genetics, immunizations, assessments and plans, medications, treatments, procedures, surgeries, recommendations, guidelines, referrals, follow-ups, organs and anatomical sites and parts in and manage by said SQL Server;
a process for creating databases comprising diagnoses and related family histories, laboratories, imaging, body fluid tests and tissues examinations, genetics and immunizations related to said diagnoses in said SQL Server;
a process for deducing said diagnoses by said computer server or servers wherein said people apply or input words and terms representing chief complaints to said computer server or servers;
a process for deducing said diagnoses by said computer server or servers retrieving and displaying interactive words and terms representing reviews of systems, physical examinations, family histories, genetics, immunizations, laboratories, imaging, body fluid tests and tissues examinations, human organs and anatomical sites related to said diagnoses and chief complaints by said computer server or servers;
a process for said people to choose, select and submit said interactive words and terms representing reviews of systems, physical examinations, family histories, genetics, immunizations, laboratories, imaging, body fluid tests and tissues examinations, human organs and anatomical sites related to said diagnoses and chief complaints to said computer server or servers;
a process for repetitively adapting, adjusting and modifying said words and terms representing chief complaints in said process for deducing said individual diagnoses by said people;
a process for repetitively adapting, adjusting and modifying said words and terms representing chief complaints for retrieving and displaying interactive words and terms representing reviews of systems, physical examinations, family histories, genetics, immunizations, laboratories, imaging, body fluid tests and tissues examinations, human organs and anatomical sites related to said diagnoses and chief complaints by said people;
a process for repetitively adapting, adjusting and modifying said interactive words and terms representing reviews of systems, physical examinations, family histories, genetics, immunizations, laboratories, imaging, body fluid tests and tissues examinations, human organs and anatomical sites related to said diagnoses and chief complaints by said people;
a process for scanning, checking, comparing and/or matching common, same, equivalent, like or similar words and terms in and among corresponding said submitted reviews of systems, physical examinations, laboratories, imaging, body fluid tests and tissues examinations, family histories, genetics, immunizations, human organs and anatomical sites and parts related to said diagnoses and chief complaints by said computer server or servers;
a process for scanning, checking, comparing and identifying matchless, different, distinct, unique or unrepeatable words and terms in and among corresponding said submitted reviews of systems, physical examinations, laboratories, imaging, body fluid tests and tissues examinations, family histories, genetics, immunizations, human organs and anatomical sites and parts related to said diagnoses and chief complaints by said computer server or servers;
a process for excluding diagnoses related to said reviews of systems, physical examinations, laboratories, imaging, body fluid tests and tissues examinations, family histories, genetics and immunizations comprising common, same, equivalent, like or similar words and terms by said computer server or servers;
a process for not selecting diagnoses related to said excluded reviews of systems, physical examinations, laboratories, imaging, body fluid tests and tissues examinations, family histories, genetics and immunizations comprising common, same, equivalent, like or similar words and terms by said computer server or servers by said computer server or servers;
a process for including individual diagnoses related to said submitted reviews of systems, physical examinations, laboratories, imaging, body fluid tests and tissues examinations, family histories, genetics, immunizations, human organs and anatomical sites and parts comprising uncommon, matchless, distinct, different, unique or unrepeatable words and terms by said computer server or servers;
a process for selecting individual diagnoses related to said submitted reviews of systems, physical examinations, laboratories, imaging, body fluid tests and tissues examinations, family histories, genetics, immunizations, human organs and anatomical sites and parts comprising uncommon, matchless, distinct, different, unique or unrepeatable words and terms by said computer server or servers;
a process for selecting individual groups of diagnoses related to said selected individual diagnoses by said computer server or servers;
a process for selecting differential diagnoses related to said selected individual diagnoses by said computer server or servers;
a process for showing the products or outcomes of said processes on the viewing screens of said computers, portable and wireless electronic communication devices use by said individuals;
a process for enabling said individuals to effect the deductions of said diagnoses;
by said computer server or servers using said computers, portable and wireless electronic communication devices in said network or networks; and
a process for enabling individual groups comprising physicians and patient or patients to effect the deductions of said diagnoses using said computers, portable and wireless electronic communication devices in said network or networks.

15. The method for deducing individual diagnoses, individual groups of diagnoses affecting human organs, parts and anatomical sites and related differential diagnoses by computer server or servers according to claim 14 wherein said process for said people to choose, select and submit said interactive words and terms representing reviews of systems, physical examinations, family histories, genetics, immunizations, laboratories, imaging, body fluid tests and tissues examinations, human organs and anatomical sites related to said diagnoses and chief complaints to said computer server or servers comprises a process for submitting individual batches of reviews of systems, physical examinations, family histories, genetics, immunizations, laboratories, imaging, body fluid tests and tissues examinations, human organs and anatomical sites to said computer server or servers by said people.

16. The method for deducing individual diagnoses, individual groups of diagnoses affecting human organs, parts and anatomical sites and related differential diagnoses by computer server or servers according to claim 14 wherein said process for repetitively adapting, adjusting and modifying said interactive words and terms representing reviews of systems, physical examinations, family histories, genetics, immunizations, laboratories, imaging, body fluid tests and tissues examinations, human organs and anatomical sites related to said diagnoses and chief complaints comprises a process for submitting adapted, modified or edited individual batches of reviews of systems, physical examinations, family histories, genetics, immunizations, laboratories, imaging, body fluid tests and tissues examinations, human organs and anatomical sites to said computer server or servers by said people.

17. The method according to claim 14 wherein said process for deducing said diagnoses by said computer server or servers wherein said people apply or input words and terms representing chief complaints to said computer server or servers comprises a process for selecting and displaying diagnoses related to said inputs representing said chief complaints from said database or databases comprising diagnoses by said computer server or servers.

18. The method according to claim 14 wherein said process for deducing said diagnoses by said computer server or servers wherein said people apply or input words and terms representing chief complaints to said computer server or servers comprises a process for selecting and displaying individual groups of differential diagnoses related to said selected individual diagnoses from said database or databases by said computer server or servers.

19. The method according to claim 14 wherein said process for deducing said diagnoses by said computer server or servers wherein said people apply or input words and terms representing chief complaints to said computer server or servers comprises a process for selecting and displaying individual groups of diagnoses related to said selected individual diagnoses from said database or databases by said computer server or servers.
